(19) United States
(12) Patent Application Publication
(10) Pub. No.: US 2022/0212568 A1
(43) Pub. Date: Jul. 7, 2022

(54) FASTENING HOOK FOR SECURING FURNITURE TO SEAT MOUNTS IN VEHICLES

(71) Applicant: Josh Rifkin, Carlsbad, CA (US)

(72) Inventor: Josh Rifkin, Carlsbad, CA (US)

(21) Appl. No.: 17/567,595

(22) Filed: Jan. 3, 2022

Related U.S. Application Data
(60) Provisional application No. 63/134,305, filed on Jan. 6, 2021.

(51) Int. Cl. B60N 2/015

(52) U.S. Cl. CPC B60N 2/01583; B60N 2/01541

(57) ABSTRACT

A U-shaped hook which hooks itself into the existing tracking system of a van, and where a bolt and washer combination is used to secure any physical object to the tracking system of the van by pulling the U-shaped hook up into the cross bar of the tracking system, allowing for a quick and easy van conversion from a working or passenger van into a recreational vehicle.

### CROSS REFERENCE TO RELATED APPLICATIONS

This application claims priority back to U.S. Provisional No. 63134305, filed Jan. 6, 2021, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of mechanical devices and vehicle conversions, and more specifically to a van conversion system that allows for a passenger or cargo van to quickly and easily transform into a recreational vehicle without permanently altering the internal structure of the vehicle.

### Brief Description of Invention

The present invention is a U shaped hook which hooks itself into the existing tracking system of a van, and where a bolt and washer combination is used to secure any physical object to the tracking system of the van by pulling the U shaped hook up into the cross bar of the tracking system.

### BACKGROUND OF THE INVENTION

Vans have many uses. During the week it may be used as a passenger van with attached seat rows, meant to transport the family from place to place, or it might be used as a delivery truck with open cargo space to support a trade or delivery business. On the weekend, the same van owner may wish to turn either of the aforementioned into a van that can be used for day camping, a beach day or a quick weekend getaway.

Typically, rows of seats are bolted into elongated tracks built into or embedded into the floor of the van. These tracks typically run from the front of the vehicle to the rear of the vehicle. Many use either an E-track or L-track (airline track) system, which in many industries is used to secure cargo to the floor, including the airline industry. Ultimately, both of these systems require a full installation of the rails throughout the van interior. The L-Track system was used to secure seats to the floor of an aircraft, but it later made its way into ground transport vehicles, and now more commonly into recreation vehicles used for camping and outdoor leisure/recreation, where it is used to secure items to the floor and walls of sprinter and cargo vans as well as other vehicles. The downside of this system is, it does not allow for easy conversion; as it requires a complete re-haul of the interior of the vehicle. As well, many van conversions permanently alter the vehicle by building furniture that is fastened to the metal floor or walls of a vehicle with screws. Additionally, some conversion systems require a custom floor to transform the van into a recreational vehicle. And again, the drawback of these systems, is that they are require permanent alteration of the interior of the van and to remove the seats from and E-track or L-track system, and replace them with a bench or table is time consuming, frustrating, labor intensive and may possibly cause damage to the interior of the van.

There exists several van conversion systems in the marketplace, but none of them use the manufacturers' elongated tracks to fasten objects like a bench or kitchenette to the vehicle floor. As well, many of them require a permanent and costly alteration of the interior of the van.

There are a number of fastening mechanisms like a U-bolt that can secure an object to the seat mount or track, but once the object is placed over the seat mount, it is very difficult to line up the holes with the 2 bolts due to zero visibility. Additionally, the U-bolts would have no way to stand on their own and stay in place without an additional supporting part.

Statement of the Problem. Thus, a quick and easy solution for attaching structures to the tracks of a van is desired.

Solution Presented: The current invention provides just such a solution by having a U-shaped hook which hooks itself into the existing tracking system of a van, and where a bolt and washer combination is used to secure any physical object to the tracking system of the van by pulling the U shaped hook up into the cross bar of the tracking system.

### Objects of the Invention

It is an object of the present invention to provide a quick and easy system for van conversions.

It is an object of the present invention to provide a means for attaching physical structures to the floors or walls of a van.

It is an object of the present invention to provide a means for attaching any physical structures to the floors or walls of a van by means of a locking system.

It is an object of the present invention to provide a means for quickly and easily securing a locking system to the existing track of any van.

It is an object of the present invention to provide a means for securing furniture or any physical structure to the floor of any van.

It is an object of the present invention to provide a means for securing a structure to the track of by means of a tool, which supplies upward pressure from beneath the tracks bar.

It is an object of the present invention to provide a quick and easy means for securing and releasing hardware to any tracking system of any van.

### Statement of the Invention

The invention is a U-shaped hook which hooks itself into the existing tracking system of a van, and where a bolt and washer combination is used to secure any physical object to the tracking system of the van by pulling the U shaped hook up into the cross bar of the tracking system.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view that illustrates a 3-dimensional view of a U shaped hook with a bolt and washer.

FIG. 2 is a front view that illustrates a cross section of FIG. 1

FIG. 3 is a perspective view that illustrates a U-shaped hook as it relates to a track system.

FIG. 4 is a front view that illustrates a cross section of the U-shaped hook engaging with the rod of a track system.

FIG. 5 is a front view that illustrates the U-shaped hook fully engaged with the rod of a track system.

FIG. 6 is a front view that illustrates another embodiment of a U-shaped hook.

FIG. 7 is a front view that illustrates another embodiment that pertains to a U-shaped hook.

FIG. 8 is a front view of another embodiment of the invention, with an eyelet bolt to allow a user of the invention to tie off something, such as a dog leash, to the bolt.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

To the accomplishment of the above and to such further objects as may hereinafter appear, the present invention relates to a means for securing physical structures to the existing tracks of a van, substantially as defined in the appended claims and as described in the following specification of several embodiments as considered in conjunction with the accompanying drawings, in which:

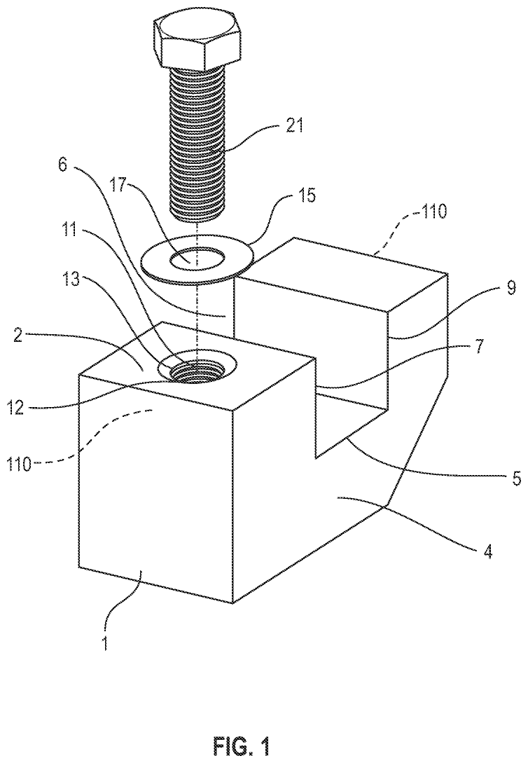

FIG. 1 is a perspective view that illustrates a 3-dimensional view of a U shaped hook with a bolt and washer.

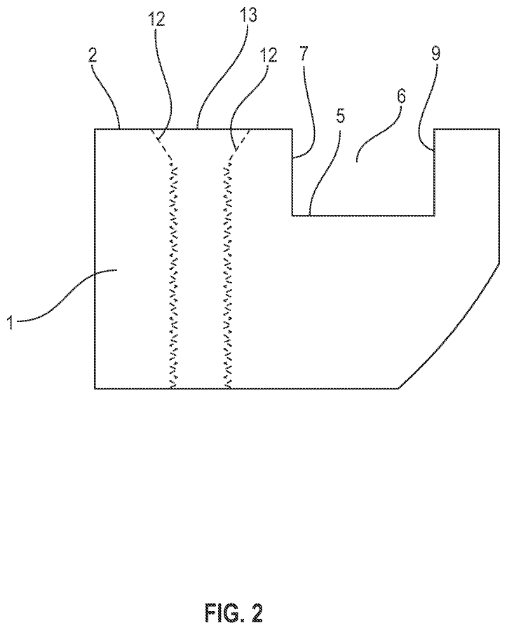

FIG. 2 is a front view that illustrates a cross section of FIG. 1

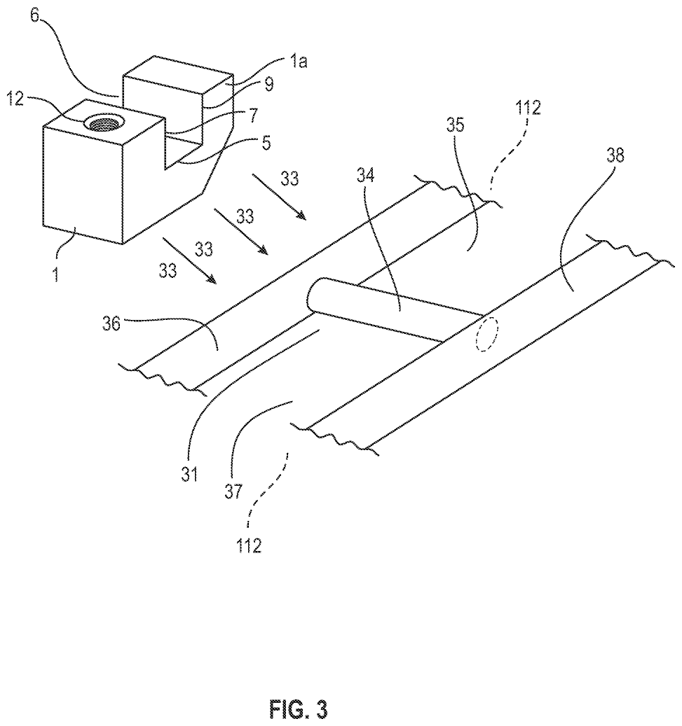

FIG. 3 is a perspective view that illustrates a U-shaped hook as it relates to a track system.

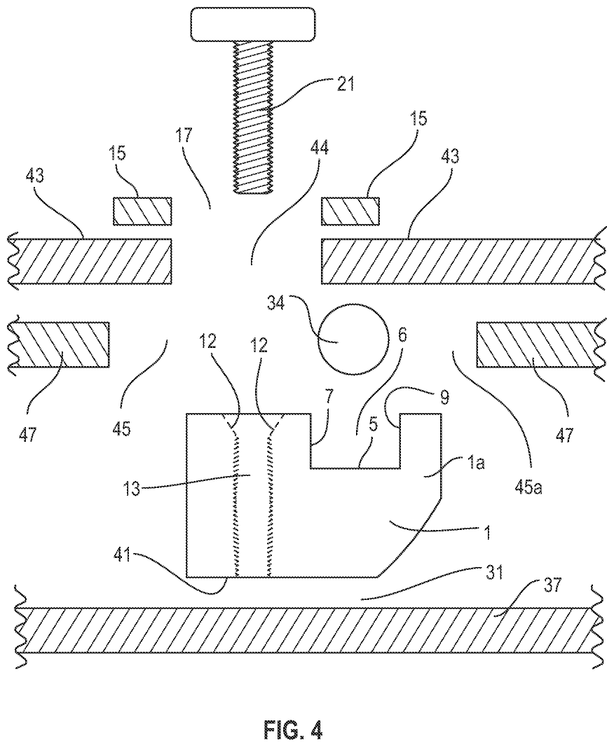

FIG. 4 is a front view that illustrates a cross section of the U-shaped hook engaging with the rod of a track system.

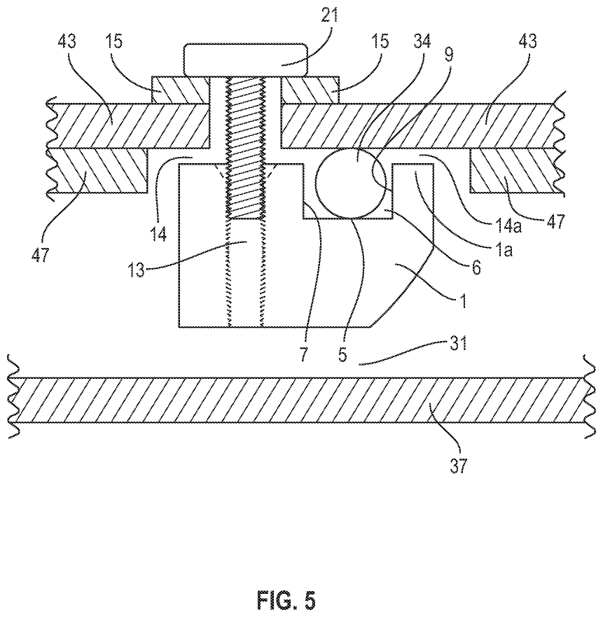

FIG. 5 is a front view that illustrates the U-shaped hook fully engaged with the rod of a track system.

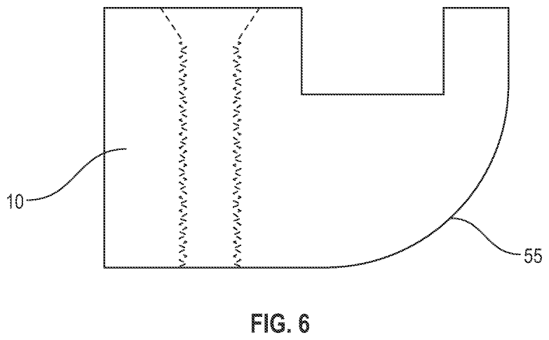

FIG. 6 is a front view that illustrates another embodiment of a U-shaped hook.

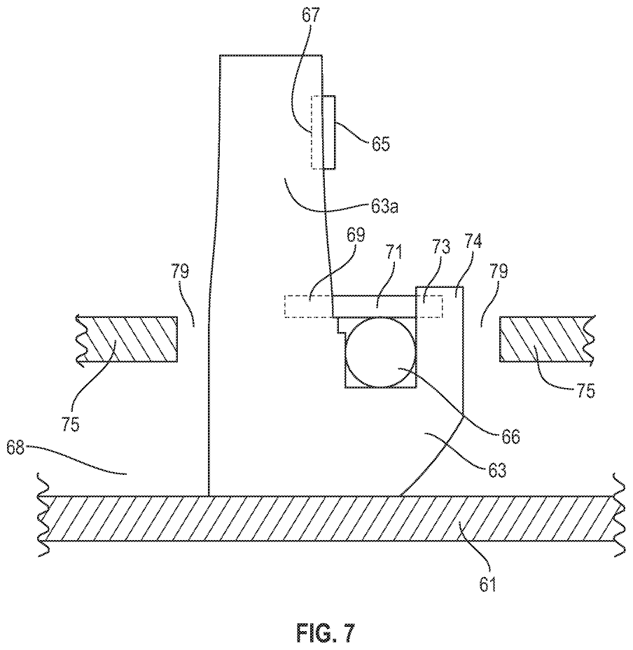

FIG. 7 is a front view that illustrates another embodiment that pertains to a U-shaped hook.

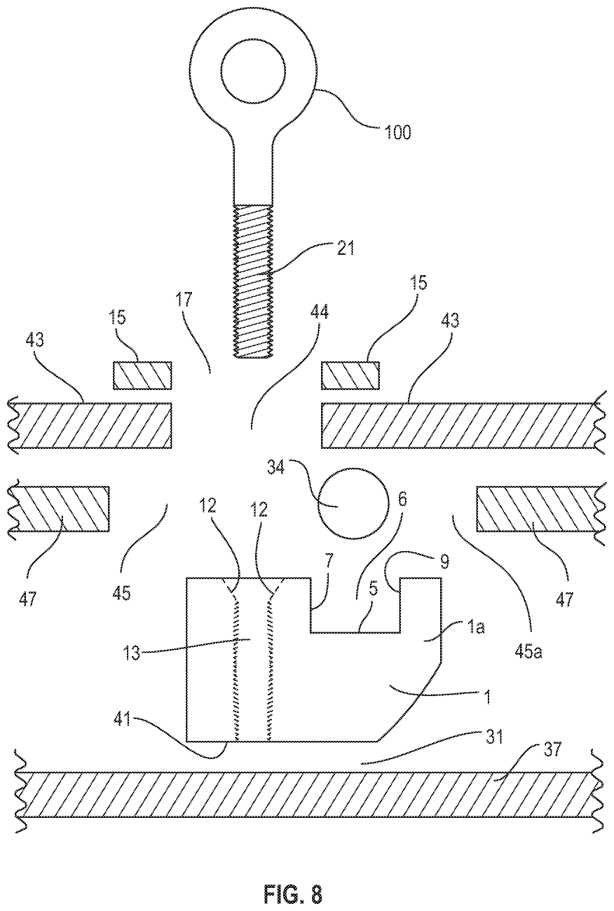

FIG. 8 is a front view of another embodiment of the invention, with an eyelet bolt to allow a user of the invention to tie off something, such as a dog leash, to the bolt.

Referring now to the drawings, there is shown in FIG. 1, a first embodiment of the present invention where we see a 3-dimensional view of U shaped hook 1. Bolt 21 sits above washer 15 having opening 17. Washer 15 sits above surface 2, which houses receiving hole 13. Hole 13 has threads 11 etched into its interior, which is meant to receive mating threads from bolt 21. Sloping edge 12 allows for the easy finding of hole 13. Front Surface 4 incorporates the U-shaped canal 6, formed by walls 5, 7, and 9. Lines 110 depict a cross sectional view.

FIG. 2 shows FIG. 1 at cross section 110. Here canal 6 is seen formed by walls 5, 7, and 9. We also see hole 13 extending downward into hook 1 at surface 2.

FIG. 3 shows U hook 1 in proximity to track 35. Track 35 is formed by a floor 37, vertical walls 36, and 38 thus creating a channel. Rod 34 is built into or embedded into walls 36 and 38 and its sits raised above floor 37, leaving under space 31 open to receiving U hook 1. In use, the user takes U hook 1, and by means of arrows 33 he slides hook 1 over to track 35, and then takes portion 1a and scoops it under rod 34, leaving hook 1 to now rest within track 35, which will be exhibited in more detail in FIG. 4, by viewing cross section 112. The hook sits flat and firmly on the floor of the track and the width prevents it from moving side to side. Additionally, the wall 5, 7, and 9 contains the seat mount's rod 34, which prevents the U hook from moving front to back. Now you have a secured fastening hook in the exact position of the track 35. You can then place an object like a bench on top of the van's floor and easily and blindly insert a bolt into the opening of the bench and the opening in floor and find the threaded and sloping edge 12 and receiving hole 13 to begin the fastening process. To account for slight variations sloping edge 12 allows hole 13 to be found with ease.

FIG. 4 illustrates a side view of how U hook 1 would be positioned before engaging itself to bar 34 of track 35. Here we see bolt 21 positioned above opening 17 of washer 15. Below washer 15 is surface 43, which may be the bottom of a cabinet, a table, a chair, or any item that the user wishes to bond to the floor of the van. Surface 43 has opening 44 cut from its surface area. Below surface area 43 is the floor 47 of the van, which has opening 45 and 45a. Between the openings of floor 47 we see rod 34, which is positioned above canal 6 of U hook 1. We also see receiving hole 13. Surface 41 shows the lower surface of U hook 1, which hovers above the floor 37 in the open under space 31, which exists within track 35.

In use, the user lines up all the pieces as described. The user takes bolt 21 and enters it through space 17, 44, and 45 and directly into hole 13. With a wrench he then turns the bolt clockwise, which causes hook 1 to rise upward toward surface 43. He turns bolt 21 until lower wall 5 of hook 1 is fully engaged and in contact with the surface of bar 34, as see in FIG. 5. It is the upward pressure from wall 5, which keeps hook 1 securely in place, which also keeps the mounted furniture or structure securely in place within the van. By having hook 1 securely filling the space within track 35, and by having wall 5 secured to bar 34 by upward pressure, the moving or sliding forward, backward or sideways of object or surface 43 is prevented.

Gaps 14 and 14a show a space that is left between hook 1 and surface 43. It is possible that hook 1 may be fabricated so that its size will fully fill this space, or part of this space.

FIG. 6 illustrates an embodiment similar to FIG. 1, but here U hook 1a, has a curved portion 55, which would allow the U-hook to fit the tracks of any Mercedes Sprinter Vans.

FIG. 7 illustrates an embodiment similar to those seen in FIGS. 1 to 6, but here, U hook 63 sits flush on the floor 61 of a track, and extends upwards through floor 75 at opening 79, hooking itself under rod 66.

FIG. 7 illustrates yet another embodiment of the invention. In use, the user takes hold of button 65 on upper portion of u hook 63 at Squeeze Point 70, and squeezes it, which causes a spring loading internal mechanism to retract slide 71 into cavity 69 of 70. He then takes U-hook 63, and in a scooping motion hooks it through opening 79 of floor 75 into channel 68, and wraps it underneath rod 66, allowing for a firm position where the bottom of U-hook 63 is flush with floor 61 of channel 68, and u hook 63 is now snuggly fit around rod 66. He then releases button 65, which releases slide 71 from cavity 69 and allows it to stretch over rod 66 and enter cavity 73 of area 74 on u hook 63, thus securely locking u hook 63 into channel 68 and into the van's floor. The user may then add on nuts, bolts straps, or connectors, or any attaching mans to portion 63a, which will allow for any type of furniture or object to be securely connected to the van's floor or wall tracking system.

When the user is ready to remove u hook 63 from channel 68, he simply presses button 65 into cavity 67, causing slide 71 to retract into cavity 69, and he then un-scoops hook 63 from channel 68.

It is to be noted, that for the U hook, any type of metal, steel, iron, copper, carbon fiber, plastic, silicone, wood, resonated pieces, marble, stone, may be used. It is also noted that for the furniture that is to be attach to the track by the U hook, any type of furniture may be used: a cabinet, a couch, a surfboard rack, a ski rack, a bike rack, a rifle rack, a dog leash rod, a dog crate, a crate, a box, a gun storage box, a gun rack, a gym system, a stretching system, a fold out table, a sliding out table, a baby's crib, a rod, a chair, a toilet, a sink, a bike rack, a motor bike rack, a rack system for rifles or guns, a rack system for carrying glass, a rack system for carrying steel rods or wood, etc.

FIG. 8 is a front view of another embodiment of the invention, with an eyelet bolt 100 to allow a user of the invention to tie off something, such as a dog leash, to the bolt.

It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for converting cargo and passenger vans into recreational vehicles, consisting of: a bolt, a washer, and a hook,
where the bolt has a bolt head, a plurality of bolt threads and a threaded length, where the washer has a washer hole,
and where the hook has an upper surface, a front surface, a back surface, a top surface and a bottom surface, where the hook has a securing end and a hook end, where a top surface of the securing end has a threaded hole, where the threaded hole comprises a sloping edge which serves as a pilot hole, where the securing end and the hook end are separated by a canal, where the canal is bounded on a canal bottom by a bottom wall and on a securing end side by a first vertical wall, and on a hook end side by a second vertical wall, where the first vertical wall and the second vertical wall have a wall height, and where the wall height is less than a rod diameter of a rod in a floor of a van, such that the hook can be inserted below the rod with the rod resting in the canal, and the bolt can be inserted through the washer hole and through a surface, such that the bolt threads mate with the plurality of hole threads, allowing the bolt to rotate and tighten the surface against the rod, thereby securing the surface over the floor of the van.

2. A device for converting cargo and passenger vans into recreational vehicles, comprising: a bolt, a washer, and a hook,
where the bolt has a bolt head, a plurality of bolt threads and a threaded length,
where the washer has a washer hole,
and where the hook has a threaded hole and a canal.

3. The device of claim 2, where the hook has an upper surface, a front surface, a back surface, a top surface and a bottom surface, where the hook has a securing end and a hook end, where a top surface of the securing end has a threaded hole, where the threaded hole comprises a sloping edge which serves as a pilot hole.

4. The device of claim 2, where the first vertical wall and the second vertical wall have a wall height, and where the wall height is less than a rod diameter of a rod in a floor of a van, such that the hook can be inserted below the rod with the rod resting in the canal, and the bolt can be inserted through the washer hole and through a surface, such that the bolt threads mate with the plurality of hole threads, allowing the bolt to rotate and tighten the surface against the rod, thereby securing the surface over the floor of the van.

5. The device of claim 2, where the securing end and the hook end are separated by a canal, where the canal is bounded on a canal bottom by a bottom wall and on a securing end side by a first vertical wall, and on a hook end side by a second vertical wall.

6. The device of claim 2, where the threaded length of the bolt is greater than the rod diameter.

7. The device of claim 2, where the canal has a canal height, and the canal height is less than the rod diameter.

8. The device of claim 2, where the bolt is an eyelet bolt.

9. The device of claim 2, where the hook has an upper surface, a front surface, a back surface, a top surface and a bottom surface, where the hook has a securing end and a hook end, where a top surface of the securing end has a threaded hole, where the threaded hole comprises a sloping edge which serves as a pilot hole, where the first vertical wall and the second vertical wall have a wall height, and where the wall height is less than a rod diameter of a rod in a floor of a van, such that the hook can be inserted below the rod with the rod resting in the canal, and the bolt can be inserted through the washer hole and through a surface, such that the bolt threads mate with the plurality of hole threads, allowing the bolt to rotate and tighten the surface against the rod, thereby securing the surface over the floor of the van.

10. The device of claim 9, where the securing end and the hook end are separated by a canal, where the canal is bounded on a canal bottom by a bottom wall and on a securing end side by a first vertical wall, and on a hook end side by a second vertical wall, where the threaded length of the bolt is greater than the rod diameter, where the canal has a canal height, and the canal height is less than the rod diameter.

11. The device of claim 10, where the bolt is an eyelet bolt.

12. A method of converting a van into a recreational vehicle, comprising the steps of first, obtaining a hook with a bolt, second, inserting the hook under a rod on a floor of a van, third, inserting the bolt through a hole in a new floor into a hole in the hook, fourth, tightening the bolt to secure the new floor to the rod.

13. The method of claim 12, additionally comprising a washer with a washer hole, where the bolt has a bolt head, a plurality of bolt threads and a threaded length, where the washer has a washer hole, and where the hook has a threaded hole and a canal.

14. The method of claim 12, where the hook has an upper surface, a front surface, a back surface, a top surface and a bottom surface, where the hook has a securing end and a hook end, where a top surface of the securing end has a threaded hole, where the threaded hole comprises a sloping edge which serves as a pilot hole.

15. The method of claim 12, where the first vertical wall and the second vertical wall have a wall height, and where the wall height is less than a rod diameter of a rod in a floor of a van, such that the hook can be inserted below the rod with the rod resting in the canal, and the bolt can be inserted through the washer hole and through a surface, such that the bolt threads mate with the plurality of hole threads, allowing the bolt to rotate and tighten the surface against the rod, thereby securing the surface over the floor of the van.

16. The method of claim 12, where the securing end and the hook end are separated by a canal, where the canal is bounded on a canal bottom by a bottom wall and on a securing end side by a first vertical wall, and on a hook end side by a second vertical wall.

17. The method of claim 12, where the threaded length of the bolt is greater than the rod diameter.

18. The method of claim 2, where the canal has a canal height, and the canal height is less than the rod diameter.

19. The method of claim 12, where the hook has an upper surface, a front surface, a back surface, a top surface and a bottom surface, where the hook has a securing end and a hook end, where a top surface of the securing end has a threaded hole, where the threaded hole comprises a sloping edge which serves as a pilot hole, where the first vertical wall and the second vertical wall have a wall height, and where the wall height is less than a rod diameter of a rod in a floor of a van, such that the hook can be inserted below the rod with the rod resting in the canal, and the bolt can be inserted through the washer hole and through a surface, such that the bolt threads mate with the plurality of hole threads, allowing the bolt to rotate and tighten the surface against the rod, thereby securing the surface over the floor of the van.

20. The method of claim 19, where the securing end and the hook end are separated by a canal, where the canal is bounded on a canal bottom by a bottom wall and on a securing end side by a first vertical wall, and on a hook end side by a second vertical wall, where the threaded length of the bolt is greater than the rod diameter, where the canal has a canal height, and the canal height is less than the rod diameter.
